(19) United States
(12) Patent Application Publication
(10) Pub. No.: US 2014/0268170 A1
(43) Pub. Date: Sep. 18, 2014

(54) APPARATUS AND METHOD FOR ESTIMATING DEPTH OF BURIED DEFECT IN SUBSTRATE

(71) Applicant: Samsung Electronics Co., Ltd., Suwon-si (KR)

(72) Inventors: Jong-Cheon Sun, Seoul (KR); Jeong-Ho Ahn, Hwaseong-si (KR); Dong-Ryul Lee, Suwon-si (KR); Dong-Chul Ihm, Suwon-si (KR)

(73) Assignee: Samsung Electronics Co., Ltd., Suwon-si (KR)

(21) Appl. No.: 14/101,741

(22) Filed: Dec. 10, 2013

(30) Foreign Application Priority Data
Mar. 18, 2013 (KR) 10-2013-0028674

(51) Int. Cl. G01B 11/22

(52) U.S. Cl. CPC G01B 11/22
USPC 356/498

(57) ABSTRACT

Provided are an apparatus and a method for estimating a depth of a buried defect in a substrate. The apparatus for estimating a depth of a buried defect in a substrate includes a light source providing a source of light, an aperture through which only a part of the source of light passes, a reflecting mirror receiving and reflecting the source of light that has passed through the aperture as a first light, a lens receiving and condensing the first light, the substrate receiving and reflecting the condensed first light as a second light, a light sensor receiving the second light and sensing a brightness of the second light, and a position adjustment portion adjusting a distance between the lens and the substrate.

### CROSS-REFERENCE TO RELATED APPLICATIONS

This application is based on and claims priority from Korean Patent Application No. 10-2013-0028674, filed on Mar. 18, 2013 in the Korean Intellectual Property Office, the disclosure of which is incorporated herein in its entirety by reference.

### BACKGROUND

1. Field of the Inventive Concept

The present inventive concept relates to an apparatus and method for estimating a depth of a buried defect in a substrate.

2. Description of the Prior Art

As the degree of integration of a semiconductor device increases, the wavelength of a light source for a lithographic process decreases to improve resolution of a pattern formed on the semiconductor device. In a conventional lithographic process, an extreme ultraviolet light source using ArF (193 nm) or KrF (248 nm) excimer laser is used.

Also, as the wavelength of the light source for the lithographic process is decreased, energy emitted from the light source is increased. Accordingly, ions remaining on the surface of the semiconductor substrate can cause a photochemical reaction to take place, causing defects to occur on the surface of or within the semiconductor substrate. Such defects can lower the processing yield in the following process causing the reliability of the semiconductor device to deteriorate. Accordingly, it is important to find and remove such defects.

A defect on the semiconductor substrate can be identified using various kinds of defect detection equipment. However, it is difficult to directly observe the defect existing inside the semiconductor substrate although a defect signal may be obtained with respect to a discovery of the defect through the use of optical defect detection equipment.

### SUMMARY

One subject to be solved by the present inventive concept is to provide an apparatus for estimating a depth of a buried defect in a substrate, which can estimate a layer on which the defect exists and a type of the defect through estimation of the depth of the defect that exists inside the substrate.

Another subject to be solved by the present inventive concept is to provide a method for estimating a depth of a buried defect in a substrate, which can estimate a layer on which a defect exists and a type of defect through estimation of the depth of the defect at an interior of the substrate.

Additional advantages, subjects, and features of the inventive concept will be set forth in part in the description which follows and in part will become apparent to those having ordinary skill in the art upon examination of the following or may be learned from practice of the inventive concept.

In one aspect of the present inventive concept, there is provided an apparatus for estimating a depth of a buried defect in a substrate, which includes a light source that provides a source of light; an aperture constructed and arranged to output a portion of a source of light received at the aperture; a reflecting mirror that receives and reflects the portion of the source of light that has passed through the aperture as a first light; a lens that receives and condenses the first light; the substrate that receives and reflects the condensed first light as a second light; a light sensor that receives the second light and senses a brightness of the second light; and a position adjustment portion that adjusts a distance between the lens and the substrate.

In some, embodiments, the second light includes a first reflected light that is reflected from a surface of the substrate and a second reflected light that is reflected from the defect in the substrate.

In some embodiments, the apparatus further comprises a calculation portion that calculates the depth of the defect using information obtained from the light sensor.

In some embodiments, the information includes a path different value between the first reflected light and the second reflected light.

In some embodiments, the reflecting mirror includes a beam splitter which reflects the first light and transmits the second light.

In some embodiments, the reflecting mirror is positioned between the lens and the light sensor.

In some embodiments, the source of light includes laser beams.

In another aspect of the present inventive concept, there is provided an apparatus for estimating a depth of a buried defect in a substrate, which includes a light source providing a light source that provides a first light; a lens that receives and condenses the first light; the substrate that receives and reflects the condensed first light as a second light; a light sensor that receives the second light and senses a brightness of the second light; a position adjuster that adjusts a distance between the lens and the substrate; and a calculation portion that calculates the depth of the defect in the substrate using information obtained from the light sensor.

In some embodiments, the second light includes a first reflected light that is reflected from a surface of the substrate and a second reflected light that is reflected from the defect in the substrate.

In some embodiments, the information includes a path different value between the first reflected light and the second reflected light.

In another aspect of the present inventive concept, there is provided a method for estimating a depth of a buried defect in a substrate, which includes providing a first light toward the defect in the substrate; receiving a second light reflected from the substrate and sensing a first brightness; adjusting a distance between a lens and the substrate; providing a third light toward the defect; receiving a fourth light reflected from the substrate and sensing a second brightness; and estimating the depth of the defect using the first brightness and the second brightness.

In some embodiments, method of claim 11, further comprising: measuring a position of the defect before providing the first light; and adjusting a position of the substrate.

In some embodiments, the second light includes a first reflected light that is reflected from a surface of the substrate and a second reflected light that is reflected from the defect, and the fourth light includes a third reflected light that is reflected from the surface of the substrate and a fourth reflected light that is reflected from the defect.

In some embodiments, estimating the depth of the defect includes using a path difference value between the first reflected light and the second reflected light and a path difference value between the third reflected light and the fourth reflected light.

In some embodiments, the first light and the third light include laser beams.

In another aspect of the present inventive concept, there is provided an apparatus for to estimating a depth of a defect in a substrate, comprising: a light source that provides a source of light; a reflecting mirror that receives and reflects a first light portion of the source of light; a lens that receives and condenses the first light portion, the substrate receiving and reflecting the condensed first light portion as a second light; and a position adjustment portion that adjusts a distance between the lens and the substrate.

In some embodiments, the apparatus further comprises an aperture constructed and arranged to output a portion of a source of light received at the aperture.

In some embodiments, the apparatus further comprises a light sensor that receives the second light and senses a brightness of the second light.

In some embodiments, the second light includes a first reflected light that is reflected from a surface of the substrate and a second reflected light that is reflected from the defect.

In some embodiments, apparatus further comprises a calculation portion that calculates a depth of the defect using information obtained from the light sensor.

Other details of the present inventive concept are included in the detailed description and drawings.

### BRIEF DESCRIPTION OF THE DRAWINGS

The above and other objects, features and advantages of the present inventive concept will be more apparent from the following detailed description taken in conjunction with the accompanying drawings, in which:

FIG. 1 is an illustrative view of an apparatus for estimating a depth of a buried defect in a substrate according to an embodiment of the present inventive concept;

FIGS. 2 to 5 is a view illustrating elements of an apparatus for estimating a depth of a buried defect in a substrate according to an embodiment of the present inventive concept;

FIGS. 6A to 6C and 7 are views of different apertures of the apparatus of FIGS. 1-5;

FIG. 8 is a graph of features of an optical image of the defect existing in a substrate, in accordance with an embodiment;

FIG. 9 is a view illustrating elements of an apparatus and theoretical contents of estimation of the depth of a defect in a substrate according to an embodiment of the present inventive concept;

FIG. 10 is a graph illustrating a method for estimating an s value according to the position of the defect;

FIG. 11 is a diagram illustrating a shifting of gray levels, in accordance with an embodiment of the present inventive concept;

FIG. 12 is a view illustrating an apparatus for estimating a depth of a buried defect in a substrate according to another embodiment of the present inventive concept; and

FIG. 13 is a flowchart of a method for estimating a depth of a buried defect in a substrate according to an embodiment of the present inventive concept.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

In brief overview, aspects of the present inventive concepts include an apparatus and method for estimating a depth of a buried defect in a substrate to be described hereinafter. In particular, the apparatus and method can estimate the depth of a defect existing inside the substrate using an interference phenomenon occurring due to a path difference between a light signal that is reflected from the defect existing inside the substrate and a light signal that is reflected from the surface of the substrate. If information on the three-dimensional (3D) position of the defect and the shape of the defect is known through estimation of the depth of the defect existing inside the substrate, a layer on which the defect exists and the type of the defect can be analyzed. Further, by estimating the depth of the defect simultaneously or near simultaneously with the detection of the defect using the apparatus and method for estimating the depth of the buried defect in the substrate according to the present inventive concept in association with an optical device that detects the defect existing inside the substrate, the processes can be simplified and synergistic effects can be gained.

FIG. 1 is an illustrative view of an apparatus for estimating a depth of a buried defect in a substrate according to an embodiment of the present inventive concept. FIGS. 2 to 5 illustrate parts of an apparatus for estimating a depth of a buried defect in a substrate according to an embodiment of the present inventive concept. FIGS. 6A to 6C and 7 are views of different apertures of the apparatus of FIGS. 1-5. FIG. 8 is a graph of features of an optical image of the defect existing in a substrate, in accordance with an embodiment. Referring again to FIG. 1, an apparatus 1 for estimating for estimating a depth of a buried defect in a substrate 500. The apparatus 1 can include a light source 100, an aperture 200, a reflecting mirror 300, a lens 400, a light sensor 600, and a position adjustment portion 700.

The light source 100 provides a source of light 10. The light source 100 may be a lamp, laser, or related device constructed and arranged for emitting electromagnetic radiation in a predetermined frequency spectrum known to one of ordinary skill in the art, but is not limited thereto. The light source 100 may be, for example, a laser that emits semiconductor laser beams such as He—Ne, and the wavelength of the source of light 10 may be 500 to 700 nm. In particular, the source of light 10 may generate laser beams having a wavelength of 594 nm.

In general, the light source 100 can include an ultraviolet (UV) light source having a wavelength band of 350 nm to 400 nm that is used in a lithography process. A dry film that is exposed to the UV light can have a greatly increased light absorbance in the 600 nm region, for example, due to the dry film being doped with a chemical material in order to cause a color change to occur through the UV light source.

The aperture 200 is constructed and arranged to allow only a portion of the source of light 10 to pass therethrough. That is, the aperture 200 can receive the source of light 10 provided from the light source 100, and allow only a part of the source of light 10 to pass therethrough, and preventing the remainder of the source of light 10 from passing therethrough. The aperture 200 can be adjusted, more specifically, the diameter of an open portion of the aperture, such that coherent light is produced to reach the substrate 500 that is targeted for defect detection. Accordingly, at least one of a constructive interference and a destructive interference of the light can be observed.

For example, as illustrated in FIGS. 6A to 6C, the aperture 200 may have various shapes. Referring to FIG. 6A, the aperture 200 can have a small hole 205 that is formed in the center portion of the aperture 200, also referred to as an open portion. Here, the aperture 200 may allow the source of light 10 to pass through the center portion 205, but may intercept the source of light 10 that reaches an edge portion 210 thereof. As the diameter of the open portion 205 of the aperture 200 becomes smaller, the coherent light can be produced due to the small difference between paths of the source of light 10 passing through the open portion 205 of the aperture 200. In particular, referring to FIG. 7, assuming that the diameter of the open portion of the aperture 200 is R, then the difference between a position which the source of light 10 that has passed through the open portion of the aperture 200 reaches and the aperture 200 is L. Further assuming that the wavelength of the source of light 10 is λ, the coherent light reaches the position that the source of light 10 reaches according to Equation 1.

\sqrt{L²+R²}−L<<λ [Equation 1]

Referring to FIG. 6B, the aperture 200 may be constructed and arranged to include a ring 225 provided between a center portion 222 and an edge portion 220 of the aperture. In this case, the aperture 200 may allow the source of light 10 to pass through the ring portion 225, but may intercept the source of light 10 that reaches the center portion 222 and the edge portion 220 thereof.

Referring to FIG. 6C, the aperture 200 may include a plurality of small holes 235 that are formed in the center position thereof in the form of circles. In this case, the aperture 200 may allow the source of light 10 to pass through small holes 225, but may intercept the source of light 10 that reaches the remaining portion of the aperture 200. FIG. 6C exemplarily illustrates that two small holes are formed in the center position in the form of circles. The shape of the aperture 200 is not limited to those as illustrated in FIGS. 6A to 6C, but may have other shapes in so far as it outputs a coherent light.

Returning to FIG. 1, the reflecting mirror 300 receives and reflects the source of light 10 that has passed through the aperture 200 as a first light 20. The reflecting mirror 300 may include a beam splitter which reflects a part of the light and transmits the remainder thereof. FIG. 1 exemplarily illustrates that the reflecting mirror 300 is a beam splitter in the apparatus 1 for estimating the depth of the buried defect in the substrate according to an embodiment of the present inventive concept. Hereinafter, explanation will be made under the assumption that the reflecting mirror 300 is a beam splitter.

The reflecting mirror 300 may reflect the first light 20, and transmit a second light 30 that is reflected from the substrate 500. In particular, the reflecting mirror 300 may be positioned between the lens 400 and the light sensor 600 to reflect the first light 20 and to transmit the second light 30. However, the positions of the reflecting mirror 300 and/or lens 400, respectively, are not limited thereto.

The lens 400 receives and condenses the first light 20. FIG. 1 illustrates that the lens 400 is a single convex lens, but is not limited thereto. That is, the lens 400 can comprise a plurality of convex lenses or concave lenses to receive and condense the first light 20. However, in order to reduce an error that occurs due to a difference between the paths of the first light 20 passing through the lens 400, it is preferable that the lens 400 comprises a single lens.

The substrate 500 receives and reflects the first light 20 that is condensed through the lens 400 as the second light 30. The substrate 500 may be positioned below the lens 400. The first light 20 that is condensed through the lens 400 may reach the surface of the substrate 500 and may also reach the inside of the substrate 500. Accordingly, as shown in FIG. 3, the second light 30 may include a first reflected light 31 that is reflected from the surface 502 of the substrate 500 and a second reflected light 32 that is reflected from the defect 504 that exists inside the substrate 500. The substrate 500 may be a semiconductor substrate, such as a wafer, that is targeted for defect detection, but is not limited thereto. That is, the substrate 500 may be, for example, a semiconductor device having a plurality of layers.

The light sensor 600 receives the second light 30, and senses the brightness thereof. The light sensor 600 may receive the second light 30, sense the brightness thereof, and convert the sensed light into an electrical signal to obtain information for estimating the defect existing inside the substrate 500. The information may be information regarding a difference value between paths of the first reflected light 31 and the second reflected light 32 (shown in FIG. 3). The light sensor 600 may be a PMT (Photo Multiplier Tube), a CCD (Charge Coupled Device), or a TDI (Time Delay Integration), but is not limited thereto.

The position adjustment portion 700 adjusts a distance D between the lens 400 and the substrate 500. The distance D between the lens 400 and the substrate 500 may be adjusted so that the defect existing inside the substrate 500 is positioned at a point that is different from the point corresponding to the focal distance of the lens 400. By adjusting the distance between the lens 400 and the substrate 500, a gray level graph of an optical image of the defect existing inside the substrate 500, for example, illustrated at FIG. 8. The gray level graph is a graph in which brightness values of synthesized optical images, which are generated using information obtained from the light sensor 600 through the second light 30 that is reflected from the substrate 500 and reaches the light sensor 600, are continuously or discontinuously presented (see FIG. 8).

Specifically, referring to FIG. 4, the first reflected light 31 that is reflected from the surface of the substrate 500 reaches the light sensor 600. A first optical image I1 is generated using information obtained from the light sensor 600 through the first reflected light 31. Referring to FIG. 5, the second reflected light 32 that is reflected from the defect existing inside the substrate 500 reaches the light sensor 600. A second optical image 12 is generated using information obtained from the light sensor 600 through the second reflected light 32. A first synthesized optical image is generated in response to a synthesis of the first optical image I1 and the second optical image I2. A gray level value positioned at a first point can be obtained when the defect 504 is detected inside the substrate 500. Thereafter, the distance D between the lens 400 and the substrate 500 is adjusted. After the lens 400 and the substrate 500 are positioned so that the defect existing inside the substrate 500 is positioned at a second point that is different from the first point, the same processing is repeated. Accordingly, a second synthesized optical image is generated, and the gray level value can be obtained when the defect 504 existing inside the substrate 500 is positioned at the second point. If a plurality of synthesized optical images, which are generated by continuously or discontinuously changing the position of the defect existing inside the substrate 500, are continuously or discontinuously presented, a gray level graph can be obtained, for example, illustrated at FIG. 8. In particular, FIG. 8 illustrates the gray level graph in which a plurality of gray level values are linearly connected. The gray level values can be obtained in a state where the lens 400 and the substrate 500 are positioned so that the defect existing inside the substrate 500 is positioned at a specific point.

Hereinafter, the theoretical contents of an estimation of the depth of a defect 504 existing inside the substrate 500 using the interference phenomenon that occurs due to the path difference between the first reflected light 31 and the second reflected light 32 will be described.

FIG. 9 is a view illustrating elements of an apparatus and theoretical contents of estimation of the depth of a defect 504 in a substrate 500 according to an embodiment of the present inventive concept. The apparatus of FIG. 9 can be the same as or similar to an apparatus described in FIGS. 1-7, respectively. FIG. 10 is a graph illustrating a method for estimating an e value according to the position of the defect. FIG. 11 is a diagram illustrating a shifting of gray levels, in accordance with an embodiment of the present inventive concept.

Referring to FIG. 9, it is assumed that the refractive index of the substrate 500 is n, and that the depth of the defect existing inside the substrate 500 is α. Further, it is assumed that when the lens 400 is positioned at a point f, a path of the reflected light that is reflected from the surface of the substrate 500 is Xs(f), and a path of the reflected light that is reflected from the defect existing inside the substrate 500 is Xd(f). In this case, the path difference between the path Xs(f) of the reflected light that is reflected from the surface of the substrate 500 and the path Xd(f) of the reflected light that is reflected from the defect existing inside the substrate 500 can be expressed as follows.

Xs(f)−Xd(f)=2α/n+ε(f1) [Equation 2]

Here, 2α/n refers to a path difference occurring due to the depth α of the defect 504 existing inside the substrate 500, and ε(f1) refers to a path difference occurring due to the system of the apparatus 1 (see FIG. 1) for estimating the depth of the buried defect 504 in the substrate 500. The variable “ε(f1)” can be mathematically calculated from the information on the lens 400 and the whole system of the apparatus 1 for estimating the depth of the buried defect in the substrate.

If the light incident to the substrate 500 has a single frequency (i.e., single wavelength), then the light sensed by the light sensor 600 may be expressed as a sum of the first reflected light 31 and the second reflected light 32. That is, the light sensed by the light sensor 600 may be expressed as follows.

Ae^{jkXs(f)}+Be^{jkXd(f)}=Ae^{jkXs(f)}(1+Ce^{jk(2α/n+ε(f1))}) [Equation 3]

Here, A refers to the size of the first reflected light 31, B refers to the size of the second reflected light 32, C is B/A, and k refers to a wave number.

If it is assumed that a constructive interference, i.e., the synthesized optical image is seen bright, occurs when the lens 400 is positioned at a point f1, it can be expressed as follows.

$$k ( 2 α / n + ε ( f 1 ) ) = 2 m π \\ α = \frac{n}{2} ( \frac{2 m π}{k} - ε ( f 1 ) ) , m = 0 , 1 , 2 … \qquad [ Equation 4 ]$$

Further, if it is assumed that a destructive interference, i.e., the synthesized optical image is seen dark, occurs when the lens 400 is positioned at a point f2, it can be expressed as follows.

$$k ( 2 α / n + ε ( f 1 ) ) = 2 m π \\ α = \frac{n}{2} ( \frac{( 2 m + 1 ) π}{k} - ε ( f 2 ) ) , m = 0 , 1 , 2 … \qquad [ Equation 5 ]$$

If ε(f1) and ε(f2) can be known, then the depth α of the defect existing inside the substrate 500 can be calculated.

As described above, ε(f1) and ε(f2) are path differences generated by the system of an apparatus 1 for estimating the depth of the defect of the substrate, and can be mathematically calculated. Hereinafter, a method capable of experimentally obtaining the path differences is proposed under the assumption that a defect exists on the surface of the substrate 500.

Even in the case where the defect exists on the surface of the substrate 500, in accordance with the change of the distance D between the lens 400 and the substrate 500, the synthesized optical image is changed due to the interferences, and as a result, this is the influence caused by the path difference generated by the system of the apparatus 1 for estimating the depth of the buried defect in the substrate. In this case, since α is 0, Equation 3 can also be expressed as follows.

Ae^{jkXs(f)}+Be^{jkXd(f)}=Ae^{jkXs(f)}(1+Ce^{jkε(f1)}) [Equation 6]

In this case, if the constructive interference, whereby the synthesized optical image is seen bright, occurs, then the path difference may be expressed as follows.

$$ε ( fa ) = \frac{2 n π}{k} , n = 0 , 1 , 2 … \\ ε ( fa ) = 0 ( for n = 0 ) \qquad [ Equation 7 ]$$

Further, if the destructive interference, whereby the synthesized optical image is seen dark, occurs, the path difference may be expressed as follows.

$$ε ( fb ) = \frac{( 2 n + 1 ) π}{k} , n = 0 , 1 , 2 … \\ ε ( fb ) = \frac{π}{k} ( for n = 0 ) \qquad [ Equation 8 ]$$

Assuming that the path difference between the first reflected light 31 and the second reflected light 32, which is caused by a change of the distance D between the lens 400 and the substrate 500, is linearly changed and that the path difference generated by the system of the apparatus 1 for estimating the depth of the buried defect in the substrate is linearly changed, a linear graph can be obtained from Equation 7 and Equation 8, shown for example at FIG. 10. Accordingly, when the lens 400 is positioned at a point fi (see FIG. 9), the path difference generated by the system of the apparatus 1 for estimating the depth of the buried defect in the substrate can be estimated. By substituting values of ε(f1) and ε(f2) estimated with reference to the graph in FIG. 10 in Equation 4 and Equation 5, the depth α of the defect 504 in the substrate 500 can be estimated.

Referring to FIG. 11, a above-described theory will be schematically explained. The gray level graph includes a solid line, which corresponds to data related to a defect at a surface of a substrate 500. Further, the gray level graph includes a dotted line, which corresponds to data related to a defect existing inside the substrate 500, e.g., below the surface of the substrate. In this case, it can be recognized that the gray level graph regarding the defect existing inside the substrate 500 (dotted line) is shifted by S as compared with the gray level graph regarding the defect existing on the surface of the substrate 500 (solid line). S refers to a value related to the defect existing inside the substrate 500. By calculating this value through one or more equations, for example, described herein, the depth α of the defect existing inside the substrate 500 can be estimated.

Referring to FIG. 12, an apparatus 2 can be provided for estimating a depth of a buried defect 504 in a substrate 500 according to another embodiment of the present inventive concept will be described. Some or all elements of the apparatus 2 can be similar to or the same as those of the apparatus 1 described herein. For reasons due to brevity, an explanation of these elements with reference to the apparatus 2 of FIG. 12 will not be repeated.

In an embodiment, the apparatus 2 further includes a calculation portion 800. The calculation portion 800 calculates the depth α of a defect 504 existing in the substrate 500 using the information obtained from the light sensor 600. According to the above-described theory, the calculation portion 800 may automatically calculate the depth α of the defect existing inside the substrate 500. The information obtained from the light sensor 600 may include the path difference value between the first reflected light 31 and the second reflected light 32.

FIG. 13 is a flowchart of a method for estimating a depth of a buried defect in a substrate according to an embodiment of the present inventive concept.

Referring to FIG. 13, a first light 20 is provided toward the defect existing inside the substrate 500 (S1000). In this case, before the first light 20 is provided toward the defect existing inside the substrate 500, the position of the defect 504 in the substrate 500 may be measured, and the position of the substrate 500 may be adjusted. That is, using an optical device that detects the defect 504 in the substrate 500, a determination can be made whether the defect exists inside the substrate 500 and, if so, a location at the defect 504 exists in the substrate 500 can be measured. If the defect 504 exists inside the substrate 500, then the position of the substrate 500 may be adjusted so that the apparatus 1 or 2 for estimating the depth of the buried defect in the substrate according to the present inventive concept provides the first light 20 toward the defect existing inside the substrate 500. The first light 20 may be laser beams or other related source of electromagnetic energy.

A first brightness may be sensed through a reception of a second light 30 that is reflected from the substrate 500 (S1100). As the second light 30 reaches the light sensor 600, the first brightness can be sensed through the light sensor 600. The second light 30 may include a first reflected light 31 that is reflected from the surface of the substrate 500 and a second reflected light that is reflected from the defect existing inside the substrate 500.

The distance D between the lens 400 and the substrate 500 is adjusted (S1200). The distance D between the lens 400 and the substrate 500 can be adjusted through the position adjustment portion 700. In accordance with the change of the distance D between the lens 400 and the substrate 500, a plurality of synthesized optical images may be generated, and a plurality of gray level values may be obtained.

A third light may be provided toward the defect 504 in the substrate 500 (S1300). The path of the third light may be the same as or similar to the path of the first light 20. The third light may be laser beams or other related source of electromagnetic energy.

A second brightness may be sensed through a reception of a fourth light that is reflected from the substrate 500 (S1400). The fourth light reaches the light sensor 600, and the second brightness can be detected through the light sensor. The fourth light may include a third reflected light that is reflected from the surface of the substrate 500 and a fourth reflected light that is reflected from the defect 504 in the substrate 500.

Using the first brightness and the second brightness, the depth α of the defect existing inside the substrate 500 may be estimated (S1500). When the depth α of the defect existing inside the substrate 500 is estimated, a path difference value between the first reflected light 31 and the second reflected light 32 and the path different value between the third reflected light and the fourth reflected light may be used.

Although preferred embodiments of the present inventive concept have been described for illustrative purposes, those skilled in the art will appreciate that various modifications, additions and substitutions are possible, without departing from the scope and spirit of the inventive concept as disclosed in the accompanying claims.

What is claimed is:

1. An apparatus for estimating a depth of a buried defect in a substrate, comprising:
a light source that provides a source of light;
an aperture constructed and arranged to output a portion of a source of light received at the aperture;
a reflecting mirror that receives and reflects the portion of the source of light that has passed through the aperture as a first light;
a lens that receives and condenses the first light;
the substrate that receives and reflects the condensed first light as a second light;
a light sensor that receives the second light and senses a brightness of the second light; and
a position adjustment portion that adjusts a distance between the lens and the substrate.

2. The apparatus of claim 1, wherein the second light includes a first reflected light that is reflected from a surface of the substrate and a second reflected light that is reflected from the defect in the substrate.

3. The apparatus of claim 1, further comprising a calculation portion that calculates a depth of the defect using information obtained from the light sensor.

4. The apparatus of claim 3, wherein the information includes a path different value between the first reflected light and the second reflected light.

5. The apparatus of claim 1, wherein the reflecting mirror includes a beam splitter which reflects the first light and transmits the second light.

6. The apparatus of claim 5, wherein the reflecting mirror is positioned between the lens and the light sensor.

7. The apparatus of claim 1, wherein the source of light includes laser beams.

8. An apparatus for estimating a depth of a buried defect in a substrate, comprising:
a light source that provides a first light;
a lens that receives and condenses the first light;
the substrate that receives and reflects the condensed first light as a second light;
a light sensor that receives the second light and senses a brightness of the second light;
a position adjuster that adjusts a distance between the lens and the substrate; and
a calculation portion that calculates the depth of the defect in the substrate using information obtained from the light sensor.

9. The apparatus of claim 8, wherein the second light includes a first reflected light that is reflected from a surface of the substrate and a second reflected light that is reflected from the defect in the substrate.

10. The apparatus of claim 9, wherein the information includes a path different value between the first reflected light and the second reflected light.

11. A method for estimating a depth of a buried defect in a substrate, comprising:
providing a first light toward the defect in the substrate;
receiving a second light reflected from the substrate and sensing a first brightness;
adjusting a distance between a lens and the substrate;
providing a third light toward the defect;
receiving a fourth light reflected from the substrate and sensing a second brightness; and
estimating the depth of the defect using the first brightness and the second brightness.

12. The method of claim 11, further comprising:
measuring a position of the defect before providing the first light; and
adjusting a position of the substrate.

13. The method of claim 11, wherein the second light includes a first reflected light that is reflected from a surface of the substrate and a second reflected light that is reflected from the defect, and the fourth light includes a third reflected light that is reflected from the surface of the substrate and a fourth reflected light that is reflected from the defect.

14. The method of claim 13, wherein estimating the depth of the defect includes using a path difference value between the first reflected light and the second reflected light and a path difference value between the third reflected light and the fourth reflected light.

15. The method of claim 11, wherein the first light and the third light include laser beams.

16. An apparatus for estimating a depth of a defect in a substrate, comprising:
a light source that provides a source of light;
a reflecting mirror that receives and reflects a first light portion of the source of light;
a lens that receives and condenses the first light portion, the substrate receiving and reflecting the condensed first light portion as a second light; and
a position adjustment portion that adjusts a distance between the lens and the substrate.

17. The apparatus of claim 16, further comprising an aperture constructed and arranged to output a portion of a source of light received at the aperture.

18. The apparatus of claim 16, further comprising a light sensor that receives the second light and senses a brightness of the second light.

19. The apparatus of claim 16, wherein the second light includes a first reflected light that is reflected from a surface of the substrate and a second reflected light that is reflected from the defect.

20. The apparatus of claim 19, further comprising a calculation portion that calculates a depth of the defect using information obtained from the light sensor.
